(19) United States
(12) Patent Application Publication
(10) Pub. No.: US 2026/0204184 A1
(43) Pub. Date: Jul. 16, 2026

(54) ARTICULATING ELECTRONIC SHELF LABEL HOLDER

(71) Applicant: Fasteners for Retail, Inc., Twinsburg, OH (US)

(72) Inventor: Justin Joshua Campbell, Pecatonica, IL (US)

(73) Assignee: Fasteners for Retail, Inc., Twinsburg, OH (US)

(21) Appl. No.: 19/451,235

(22) Filed: Jan. 16, 2026

Related U.S. Application Data
(60) Provisional application No. 63/746,015, filed on Jan. 16, 2025.

(51) Int. Cl. G09F 3/16

(52) U.S. Cl. CPC G09F 3/16

(57) ABSTRACT

An attachment device includes a holder that includes a rear wall having a front side and a rear side formed on an opposite side of the rear wall than the front side. The rear wall extends from an upper end to a lower end of the rear wall formed on an opposite end of the rear wall than the upper end. The holder also includes an upper retaining lip attached to the upper end of the rear wall. The upper retaining lip includes an inward surface that faces a lower retaining lip and an outward surface that faces away from the lower retaining lip. The holder also includes a lower retaining lip attached to the lower end of the rear wall. The lower retaining lip includes an inward surface that faces the upper retaining lip and an outward surface that faces away from the upper retaining lip.

### CROSS-REFERENCE TO RELATED APPLICATION

This U.S. patent application claims priority under 35 U.S.C. §119(e) to U.S. Provisional Application 63/746,015, filed on January 16, 2025. The disclosure of this prior application is considered part of the disclosure of this application and is hereby incorporated by reference in its entirety.

### FIELD

The present disclosure relates generally to an electronic shelf label holder for merchandise display systems.

### BACKGROUND

This section provides background information related to the present disclosure and is not necessarily prior art.

Electronic shelf labels (ESLs) have become increasingly prevalent in retail environments due to their ability to streamline pricing updates and enhance the shopping experience. Unlike traditional paper labels, ESLs are digital displays that can be updated remotely and in real-time, reducing the labor and errors associated with manual price changes. Retailers use ESLs to display product prices, promotions, and other relevant information, ensuring that customers always see accurate and up-to-date information. This technology not only improves operational efficiency but also supports dynamic pricing strategies, allowing retailers to respond quickly to market changes.

In a typical retail setting, ESLs are attached to the front edge of shelves where they are easily visible to customers. However, the fixed nature of traditional ESL holders can limit their versatility, especially in stores with varying shelf designs and configurations. Shelves at different heights, angles, or orientations can make it challenging to maintain optimal visibility of the ESLs. This can lead to situations where customers have difficulty reading the labels, potentially impacting their shopping experience and the retailer's ability to communicate effectively with them.

To address these challenges, the development of a clip-on device with articulating functionality offers a significant improvement. Such a device allows ESLs to be adjusted and positioned to accommodate various shelf designs, ensuring that the labels are always visible regardless of the shelf s position or orientation. This innovation not only enhances the flexibility and usability of ESLs in diverse retail environments but also contributes to a more consistent and engaging shopping experience for consumers.

### SUMMARY

An attachment device for securing a display to a retail shelf. The attachment device includes a holder configured to receive and retain the display. The holder includes a rear wall extending from an upper end to a lower end formed on an opposite end from the upper end, an upper retaining lip attached to the upper end of the rear wall, the upper retaining lip comprising an inward surface facing the lower end and an outward surface facing away from the lower end, and a lower retaining lip attached to the lower end of the rear wall, the lower retaining lip including an inward surface facing the upper retaining lip and an outward surface facing away from the upper retaining lip.

Aspects of the disclosure may include one or more of the following optional features. In some examples, the rear wall includes a first rear rail and a second rear rail defining a channel. In some implementations, each rear rail includes side members and a base member. In some configurations, the upper retaining lip further includes at least one upper retention tab extending away from the inward surface. Optionally, the upper retaining lip further includes a forward-facing surface disposed at a distal end, a first recess, a second recess, and a third recess each formed in the forward-facing surface, the first recess disposed between the first one of the upper retention tabs and a first side of the rear wall, the second recess disposed between the first one of the upper retention tabs and the second one of the upper retention tabs, and the third recess disposed between the second one of the upper retention tabs and a second side of the rear wall.

In some examples, the lower retaining lip further comprises a first lower retention tab and a second lower retention tab. In some implementations, the lower retaining lip further comprises a release tab extending away from the lower retaining lip and configured to disengage lower retaining lip from the display. In some configurations, the system includes an articulating interface including a socket having a first cavity and a second cavity on opposite ends of the socket, the first cavity and the second cavity, a first ball element received within the first cavity and having a spherical surface and a first stem extending from the first ball element, and a second ball element received within the second cavity and having a spherical surface and a second stem extending from the second ball element.

In some implementations, the first ball element is configured to articulate within the first cavity, and the second ball element is configured to articulate within the second cavity. Optionally, the socket further comprises a base separating the first cavity from the second cavity.

In some examples, the attachment device includes a clip attached to the holder and configured to attach the attachment device to the retail shelf.

Another aspect of the disclosure provides an attachment device for securing a display to a retail shelf. The attachment device includes a holder configured to receive and retain the display, and an attachment mechanism attached to the holder and configured to attach the attachment device to the retail shelf. The attachment mechanism includes a clip comprising a front wall facing towards the holder, and a ratcheting mechanism disposed within the housing, the ratcheting mechanism comprising a push button, a lever arm attached to the holder, a locking nut, and a biasing spring, the ratcheting mechanism configured to enable rotation of the lever arm and the housing with the push button depressed and prevent rotation of the lever arm and the housing with the push button at rest.

Aspects of the disclosure may include one or more of the following optional features. In some examples, the clip further comprises an upper retention lip and a lower retention lip, the front wall connecting the upper retention lip to the lower retention lip. In some implementations, the lower retention lip includes a bottom segment attached to and extending away from the front wall and spaced apart from the upper retention lip by a first distance, a first mounting segment attached to, and extending away from the bottom segment at an oblique angle, towards the upper retention lip, and a second mounting segment having a proximal end and a distal end, the proximal end attached to the first mounting segment and extending towards the bottom segment, the second mounting surface forming an acute angle with the first mounting segment.

In some examples, the proximal end is spaced apart from the upper retention lip by a second distance that is less than the first distance, and the distal end spaced apart from the upper retention lip by a third distance that is greater than the second distance and less than the first distance.

In some implementations, the clip further comprises a first rotation shaft housing and a second rotation shaft housing each attached to the front wall of the clip, the first rotation shaft housing having an inner surface with a plurality of female grooves and the second rotation shaft housing having an inner surface without any grooves.

In some examples, the device includes a ratcheting mechanism including a push button extending through the second rotation shaft housing and at least a portion of the first rotation shaft housing, the push button having a first end and a second end opposite the first end. The device further includes a lever arm having a cylindrical passage that aligns with the first rotation shaft housing and the second rotation shaft housing, the cylindrical passage having an inner surface with a plurality of female grooves. The device further includes a locking nut having an inner surface and an outer surface, the outer surface having a plurality of outward facing ribs. The device further includes a biasing spring in communication with the locking nut and the push button, the biasing spring configured to exert a force against the locking nut and the push button causing the locking nut and the push button to move in a direction towards the second end of the push button. The device further includes a cap attached to the first rotation shaft and in contact with the biasing spring.

In some examples, the push button further has a plunger and one or more arms extending away from the first end of the push button. In some implementations, the locking nut is at least partially disposed within the cylindrical passage and at least partially disposed within the first rotation shaft with the push button is at rest and the outward facing grooves are configured to engage the female grooves of the first rotation shaft housing and the female grooves of the cylindrical passage with the push button at rest.

Another aspect of the disclosure provides an attachment device for securing a display to a retail shelf. The attachment device includes a holder configured to receive and retain the display, and a clip attached to the holder and configured to attach the attachment device to the retail shelf, the clip comprising a ratcheting mechanism comprising a push button, a lever arm attached to the holder, a locking nut, and a biasing spring, the ratcheting mechanism configured to enable rotation of the lever arm with the push button depressed and prevent rotation of the lever arm with the push button at rest.

This section provides a general summary of the disclosure, and is not a comprehensive disclosure of its full scope or all of its features.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1 is a perspective front view of an electronic shelf label holder according to an example of the present disclosure.

FIG. 2 is an exploded view of the electronic shelf label holder of FIG. 1.

FIG. 3 is a right cross-sectional view of the electronic shelf label holder of FIG. 1, taken along Line 3-3 of FIG. 1.

FIG. 4 is a perspective rear review of the electronic shelf label holder of FIG. 1.

FIG. 5 is a perspective view of an electronic shelf label holder according to an example of the present disclosure.

FIG. 6 is an exploded view of the electronic shelf label holder of FIG. 5.

FIG. 7 is a left cross-sectional view of the electronic shelf label holder of FIG. 5, taken along Line 7-7 of FIG. 5.

FIG. 8 is a perspective cross-sectional view of the electronic shelf label holder of FIG. 5, showing a push button in an extended position.

FIG. 9 is a perspective cross-sectional view of the electronic shelf label holder of FIG. 5 showing the push button in a depressed position.

FIG. 10 is a top cross-sectional view of the electronic shelf label holder of FIG. 5 with the push button in the extended position.

FIG. 11 is a top cross-sectional view of the electronic shelf label holder of FIG. 5 with the push button in a depressed position.

FIG. 12 is a perspective view of an electronic shelf label holder according to an example of the present disclosure.

FIG. 13 is an exploded view of the electronic shelf label holder of FIG. 12.

FIG. 14 is a right cross-sectional view of the electronic shelf label holder of FIG. 12, taken along Line 14-14 of FIG. 12.

FIG. 15 is a perspective front view of an electronic shelf label holder according to an example of the present disclosure.

FIG. 16 is a perspective rear view of the electronic shelf label holder of FIG. 15.

FIG. 17 is a front view of the electronic shelf label holder of FIG. 15.

FIG. 18 is a rear view of the electronic shelf label holder of FIG. 15.

FIG. 19 is a bottom view of the electronic shelf label holder of FIG. 15.

FIG. 20 is a top view of the electronic shelf label holder of FIG. 15.

FIG. 21 is a left side view of the electronic shelf label holder of FIG. 15.

FIG. 22 is a right side view of the electronic shelf label holder of FIG. 15. Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

Implementations herein are directed toward an attachment device for security a display to a retail shelf is generally shown. The attachment device may be formed of a known suitable plastic, such as a thermoplastic extrusion, or metal, such as an aluminum extrusion and may be installed on a front surface (i.e., a front edge) of a shelf, or other suitable base surface for displaying the display device. The shelf may be located in a store or other suitable location where consumers are able to purchase merchandise. The shelf may generally be described as having a shelf body extending from a front edge to an opposite rear edge and along a plane that is generally parallel to a ground surface, where the front edge and the opposite rear edge each extend perpendicular to the shelf body (i.e., perpendicular to the ground surface) and between an upper end and a lower end, where the shelf body may generally be disposed between the respective upper end and the lower end of the front edge and the rear edge. As discussed throughout, the direction from the front edge to the rear edge defines a longitudinal direction while the direction parallel to the front edge and the rear edge defines a lateral direction, and the direction from the upper end to the lower end defines a transverse direction. In some implementations, the shelf may include apertures extending through a thickness of the shelf and arranged in series adjacent to each of the front edge and the rear edge of the shelf. Portions of the attachment device may be secured to the shelf via fasteners engaging with the apertures. Additionally or alternatively, the attachment device may be secured to the shelf in any suitable manner, and the attachment device may be selectively detached from the shelf and moved, for example, to another shelf or other surface.

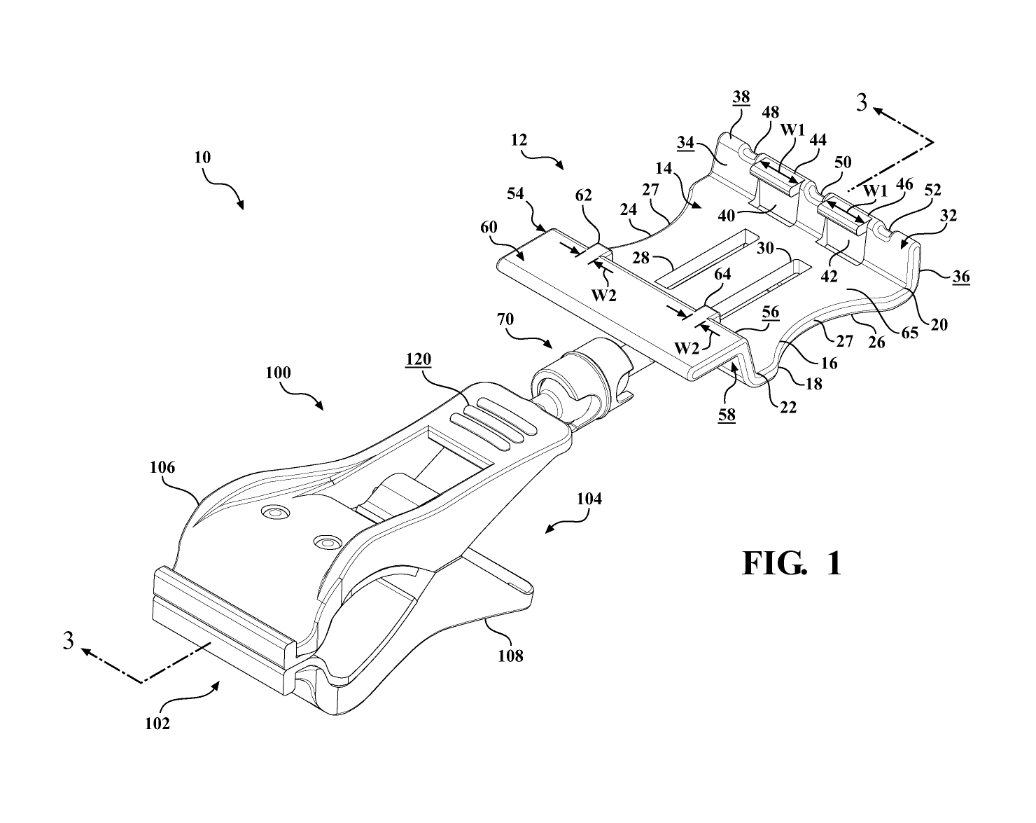

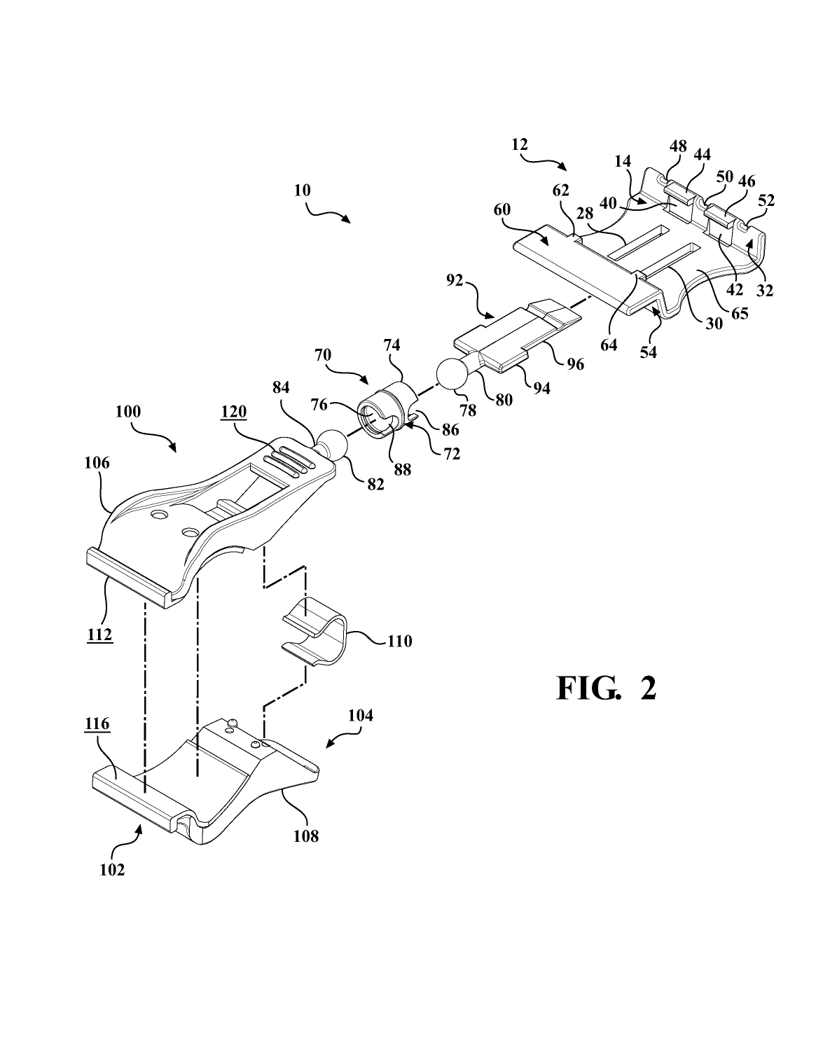

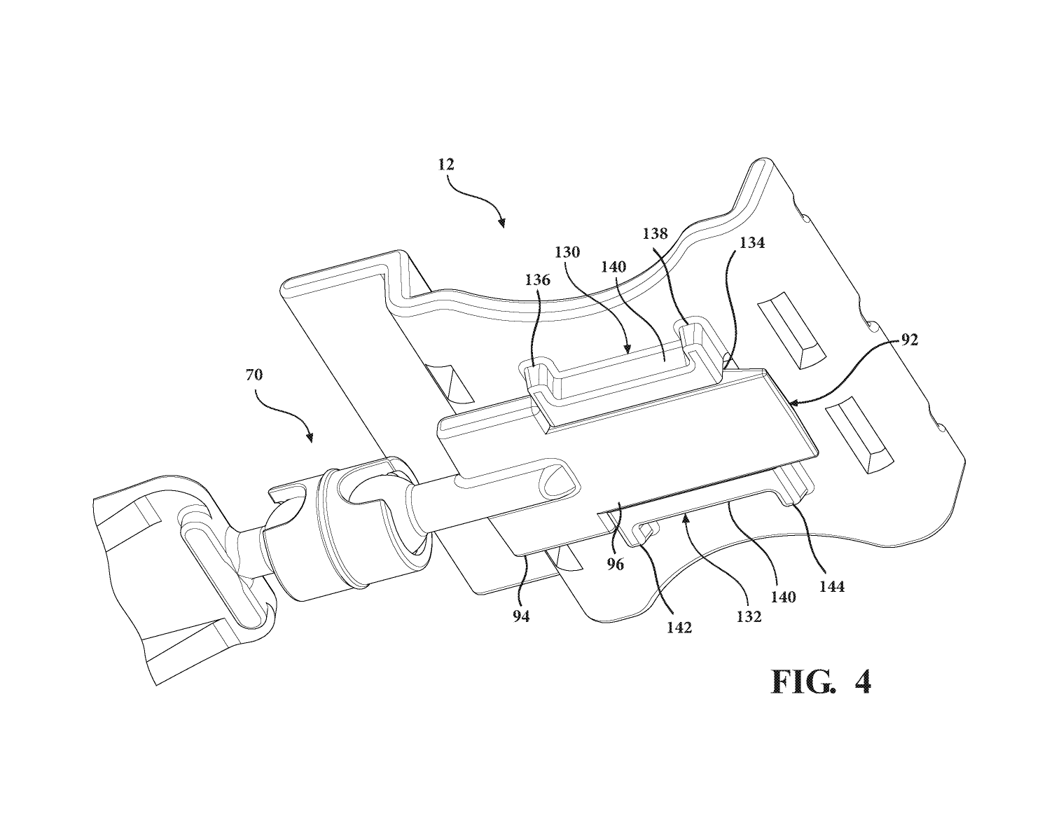

As shown in FIGS. 1-4, an attachment device includes a holder 12 that is configured to receive and retain a display device (not shown), such as an electronic shelf label (ESL) or other display. The holder 12 includes a rear wall 14 that includes a front side 16 and a rear side 18 formed on an opposite side of the rear wall 14 than the front side 16. The rear wall 14 may be defined as extending from an upper end 20 to a lower end 22 disposed on an opposite end of the rear wall 14 than the upper end 20 and extending from a first side 24 to a second side 26 disposed on an opposite side of the rear wall 14 than the first side 24. The first side 24 and the second side 26 extend from the upper end 20 to the lower end 22 and each include an arcuate recess 27 between the upper end 20 and the lower end 22.

The rear wall 14 has a thickness equal to the distance between the front side 16 to the rear side 18 of the rear wall 14. The rear wall 14 further includes a first cutout 28 and a second cutout 30 that extend through the thickness of the rear wall 14, from the front side 16 to the rear side 18. Thus, the first cutout 28 and the second cutout 30 may each include a depth that is equal to the thickness of the rear wall 14. The first cutout 28 and the second cutout 30 each include a length and a width. In some examples, the first cutout 28 and the second cutout 30 are rectangular in shape.

The first cutout 28 and the second cutout 30 are centered about the rear wall 14, meaning that the center points of the first cutout 28 and the second cutout 30 are aligned with the center point of the rear wall 14. The first cutout 28 and the second cutout 30 are generally parallel to one another and spaced apart from each other by a distance that is less than the width of the rear wall 14 (e.g., distance between the first side 24 and the second side 26). In some examples, the orientation of the first cutout 28 and the second cutout 30 is such that their lengths are generally parallel to the first side 24 and the second side 26, and their widths are generally parallel to the upper end 20 and lower end 22.

The holder 12 further includes an upper retaining lip 32 and a lower retaining lip 54. The upper retaining lip 32 is configured to engage with an upper edge of the electronic display (not shown) and prevent the electronic display from sliding out of the holder 12. The upper retaining lip 32 is attached to, and extends along, the upper end 20 of the rear wall 14 from the first side 24 to the second side 26. The upper retaining lip 32 generally extends transversely (e.g., extending crosswise) from the front side 16 of the rear wall 14 at the upper end 20. In the illustrated example, the upper retaining lip 32 is perpendicular to the front side 16 of the rear wall 14. The upper retaining lip 32 includes an inward surface 34, an outward surface 36, and a forward-facing surface 38. The inward surface 34 faces the lower retaining lip 54 and is formed on an opposite side of the upper retaining lip 32 than the outward surface 36, which faces away from the lower retaining lip 54. The forward-facing surface 38 is disposed at a distal end of the upper retaining lip 32 and extends between the inward surface 34 and the outward surface 36.

The upper retaining lip 32 further includes apertures 40, 42 that extend from the inward surface 34 through the outward surface 36. In some examples, a first aperture 40 is aligned with the first cutout 28 and a second aperture 42 is aligned with the second cutout 30 along a longitudinal direction of the holder 12 (i.e., the direction extending from the upper end 20 to the lower end 22). The upper retaining lip 32 further includes upper retention tabs 44, 46 configured to retain the electronic display (not shown). That is, the upper retention tabs 44, 46 may engage or mate with recesses in the electronic display. The upper retention tabs 44, 46 extend from the forward-facing surface 38 and away from the inward surface 34. Each of the upper retention tabs 44, 46 may include a width W1. The upper retaining lip 32 may further include recesses 48, 50, 52 formed in the forward-facing surface 38. Notably, the recesses 48, 50, 52 provide clearance for posts or flags of the ESL. This means that the recesses 48, 50, 52 create space or gaps in the holder that allow the posts or flags of the ESL to extend or project from the ESL without interfering with the holder 12. Further, the recesses 48, 50, 52 provide relief and allow additional flexibility of the retention tabs 44, 46 relative to the upper retaining lip 32. In some implementations, a first recess 48 is disposed between the upper retention tab 44 and the first side 24, a second recess 50 is disposed between the upper retention tab 44 and the upper retention tab 46, and a third recess 52 is disposed between the upper retention tab 46 and the second side 26.

The lower retaining lip 54 is configured to engage with a lower edge of the ESL and prevent it from sliding out of the holder 12. The lower retaining lip 54 extends along the lower end 22 of the rear wall 14 from the first side 24 to the second side 26. The lower retaining lip 54 generally extends transversely (e.g., extending crosswise) from the front side 16 of the rear wall 14 at the lower end 22. In the illustrated example, the lower retaining lip 54 is perpendicular to the front side 16 of the rear wall 14. The lower retaining lip 54 includes an inward surface 56, an outward surface 58, and a release tab 60. The inward surface 56 faces the upper retaining lip 32 and is formed on an opposite side of the lower retaining lip 54 than the outward surface 58 which faces away from the upper retaining lip 32. The lower retaining lip 54 includes lower retention tabs 62, 64. Each of the lower retention tabs 62, 64 may include a width W2. The width W2 of the lower retention tabs 62, 64 is smaller than the width W1 of the upper retention tabs 44, 46.

The holder 12 includes a cavity 65 defined by the rear wall 14, the upper retaining lip 32, and the lower retaining lip 54. The cavity 65 is configured to receive and retain the ESL. The cavity 65 may have a shape and size that correspond to the shape and size of the electronic display. The release tab 60 is attached to and extends from the outward surface 58 of lower retaining lip 54 in an opposite direction from the upper retaining lip 32. The release tab 60 provides an interface that a user may press to disengage the lower retention tabs 62, 64 from the electronic display. That is, when an ESL is secured by the upper retention tabs 44, 46 and the lower retention tabs 62, 64, the user may apply a force to the release tab 60 to flex the lower retaining lip 54 in a direction away from the upper retaining lip 32, which thereby causes the lower retention tabs 62, 64 to disengage from the ESL to remove the display device from the holder 12. Alternatively, the user may apply the force to the release tab 60 to increase the distance between the upper retention tabs 44, 46 and the lower retention tabs 62, 64 such that the user may generate enough clearance to insert the electronic display within the holder 12.

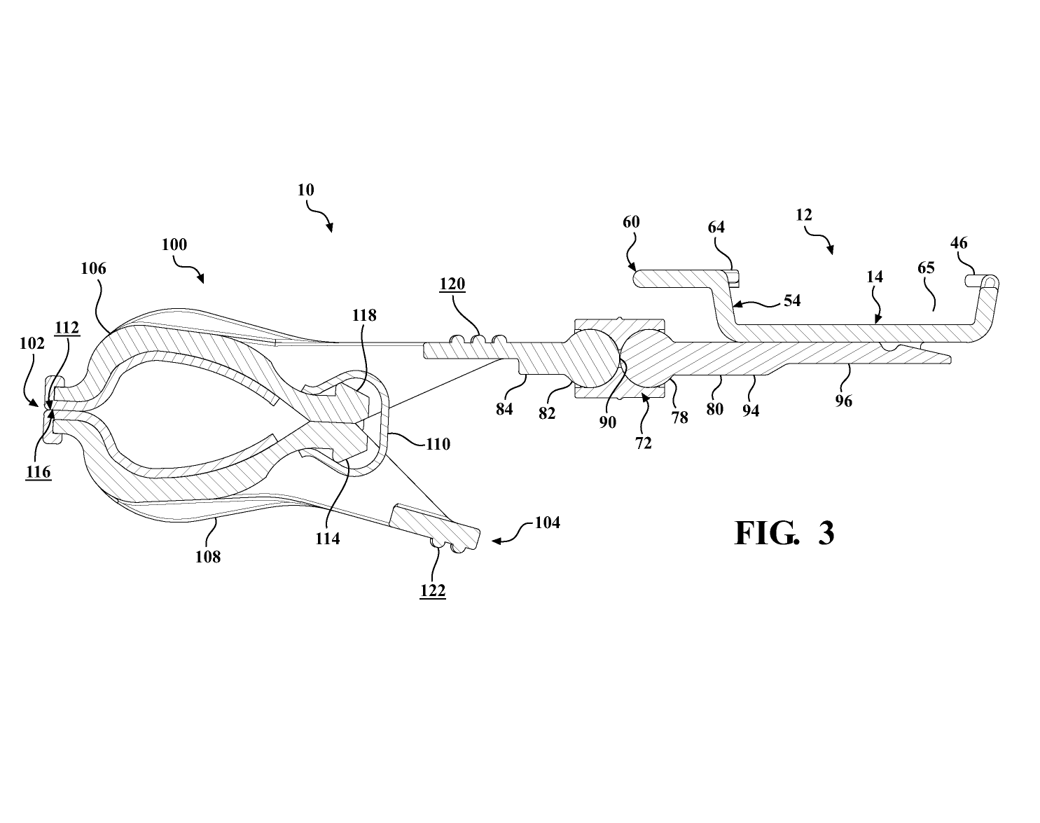

Referring now to FIGS. 1-4, in some implementations the attachment device (i.e., electronic shelf label holder) 10 includes an articulating interface 70 with a ball-socket design. That is, the articulating interface 70 includes a socket 72 with a first cavity 74 and a second cavity 76 on the opposite end of the socket 72 from the first cavity 74. The articulating interface 70 further includes a first ball element 78 that has a spherical surface and a first stem 80 that extends from the first ball element 78 and a second ball element 82 that has a spherical surface and a second stem 84 that extends from the second ball element 82. The first cavity 74 defines a concave cavity that is adapted to receive the spherical surface of the first ball element 78. Similarly, the second cavity 76 defines a concave cavity that is adapted to receive the spherical surface of the second ball element 82. Moreover, the socket 72 includes a base 90 (FIG. 3) that separates the first cavity 74 from the second cavity 76.

The opening of the first cavity 74 and the second cavity 76 may be smaller than the diameter of the first ball element 78 and the second ball element 82 such that the first ball element 78 and the second ball element 82 are inserted into their respective cavities by applying a force that expands the socket 72 to provide a captive fit within the cavities 74, 76. The first cavity 74 has an inner surface that is in contact with the spherical surface of the first ball element 78 and that defines a frictional fit between the inner surface and the first ball element 78. The frictional fit allows for the swivel, rotation, and articulation movement of the first ball element 78 within the first cavity 74, while providing a resistance that prevents the first ball element 78 from loosely rotating or dislodging from the first cavity 74. Similarly, the second cavity 76 has an inner surface that is in contact with the spherical surface of the second ball element 82 and that defines a frictional fit between the inner surface and the second ball element 82. The frictional fit allows for the swivel, rotation, and articulation movement of the second ball element 82 within the second cavity 76, while providing a resistance that prevents the second ball element 82 from loosely rotating or dislodging from the second cavity 76.

The first cavity 74 includes a first recess 86 in the sidewall of the socket 72 and the second cavity 76 includes a second recess 88 in the sidewall of the socket 72. The first recess 86 and the second recess 88 enables the first ball element 78 and the second ball element 82 to be inserted into, and removed from, the socket 72 with less force by permitting the outer sidewalls of the socket 72 to deflect in the radial direction as the ball elements 78, 82 are inserted. Notably, the first ball element 78 may move with respect to the socket 72 independent from any movement (or lack of movement) from the second ball element 82. Likewise, the second ball element 82 may move with respect to the socket 72 independent from any movement (or lack of movement) from the first ball element 78. This dual movement enables for enhanced articulation of the ESL.

The attachment device 10 may further include a connection mechanism 92. The connection mechanism 92 attaches to, and extends from, the first stem 80 and includes a lower portion 94 and an upper portion 96. Particularly, the lower portion 94 may be attached to the first stem 80 whereby the upper portion 96 is attached to the rear side 18 of the rear wall 14 of the holder 12. Thus, the connection mechanism 92 connects the articulating interface 70 to the holder 12. The connection mechanism 92 may attach the first cutout 28 and the second cutout 30 of the holder 12.

The rear wall 14 of the holder 12 includes a first rear rail 130 and a second rear rail 132. The first rear rail 130 and the second rear rail 132 define a channel 134 that receives and secures the upper portion 96 of the connection mechanism 92. Each rear rail 130, 132 is generally U-shaped. The first rear rail includes side members 136, 138 and a base member 140. The side members 136, 138 extend perpendicularly from the ends of the base member 140. Moreover, the side members 136, 138 are spaced apart by a distance that corresponds to a length of the base member 140. The base member 140 may define a first boundary of the channel 134. Similarly, the second rear rail 132 mirrors the structure of the first rear rail 130. The second rear rail 132 also includes side members 142, 144 and a base member 146. The side members 142, 144 extend perpendicularly from the ends of the base member 146. Moreover, the side members 142, 144 are spaced apart by a distance that corresponds to a length of the base member 146. The base member may define a second boundary of the channel 136.

The channel 134, defined by the first rear rail 130 and the second rear rail 132 is configured to receive and secure the upper portion 96 of the connection mechanism 92. The base members 140, 146 of the rear rails 130, 132 form the channel 134. That is, the base members 140, 146 interface with the sides of the upper portion 96 such that the base members 140, 146 secure the connection mechanism 92 to the holder 12. As such, the base members 140, 146 provide lateral support for the connection mechanism 92 within the holder 12. The side member 136 of the first rear rail 130 and the side member 142 of the second rear rail 132 also contact a top side of the lower portion 94 of the connection mechanism 92. Thus, the side members 136, 142 provide vertical support for the connection mechanism 92 within the holder 12.

In some examples, the upper portion 96 of the connection mechanism 92 includes a release member 148. The release member 148 includes a tapered width that defines an angled gap 150 (FIG. 3) between the connection mechanism 92 and the holder 12. The angled gap 150 enables a user to insert their finger or another tool into the angled gap 150. By applying a force in the angled gap 150, the user can easily remote the connection mechanism 92 from the holder 12.

The clip 100 is configured to attach the electronic shelf label holder to a shelf edge or other support structure. The clip 100 has a first end 102 that faces away from the holder 12 and a second end 104 that faces the holder 12 and is opposite the first end 102. The clip 100 includes a first jaw 106, a second jaw 108, and a biasing clip 110. The first jaw 106 includes a first clamping surface 112 at the first end 102 of the clip 100 and a first clamp member 114. The second jaw 108 includes a second clamping surface 116 at the first end 102 of the clip 100 and a second clamp member 118. The biasing clip 110 biases the first jaw 106 and the second jaw 108 towards the closed position. The biasing clip 110 attaches to, and exerts a force upon, the first clamp member 114 and the second clamp member 118 that causes the first clamping surface 112 and the second clamping surface 116 to move towards one another. The first jaw 106 includes a first ribbed surface 120 at the second end 104 of the clip 100 and the second jaw 108 includes a second ribbed surface 122 at the second end 104 of the clip 100. A user may apply a force to the first ribbed surface 120 and the second ribbed surface 122 to open the clip 100.

The first clamping surface 112 and the second clamping surface 116 are configured to grip a shelf edge or other support structure securely and prevent slippage or detachment of the electronic shelf label holder. The first clamping surface 112 and the second clamping surface 116 may have various shapes, sizes, and textures to accommodate different types and thicknesses of shelf edges or other support structures. For example, the first clamping surface 112 and the second clamping surface 116 may have flat, curved, serrated, or rubberized surfaces.

The first ribbed surface 120 and the second ribbed surface 122 are configured to provide a user with a tactile and visual indication of where to apply a force to open the clip 100. The first ribbed surface 120 and the second ribbed surface 122 may have various shapes, sizes, and patterns to facilitate the user's grip and manipulation of the clip 100. For example, the first ribbed surface 120 and the second ribbed surface 122 may have longitudinal, transverse, diagonal, or spiral ribs. The first ribbed surface 120 and the second ribbed surface 122 may also have different colors, markings, or symbols to distinguish the clip 100 from other components of the electronic shelf label holder 10

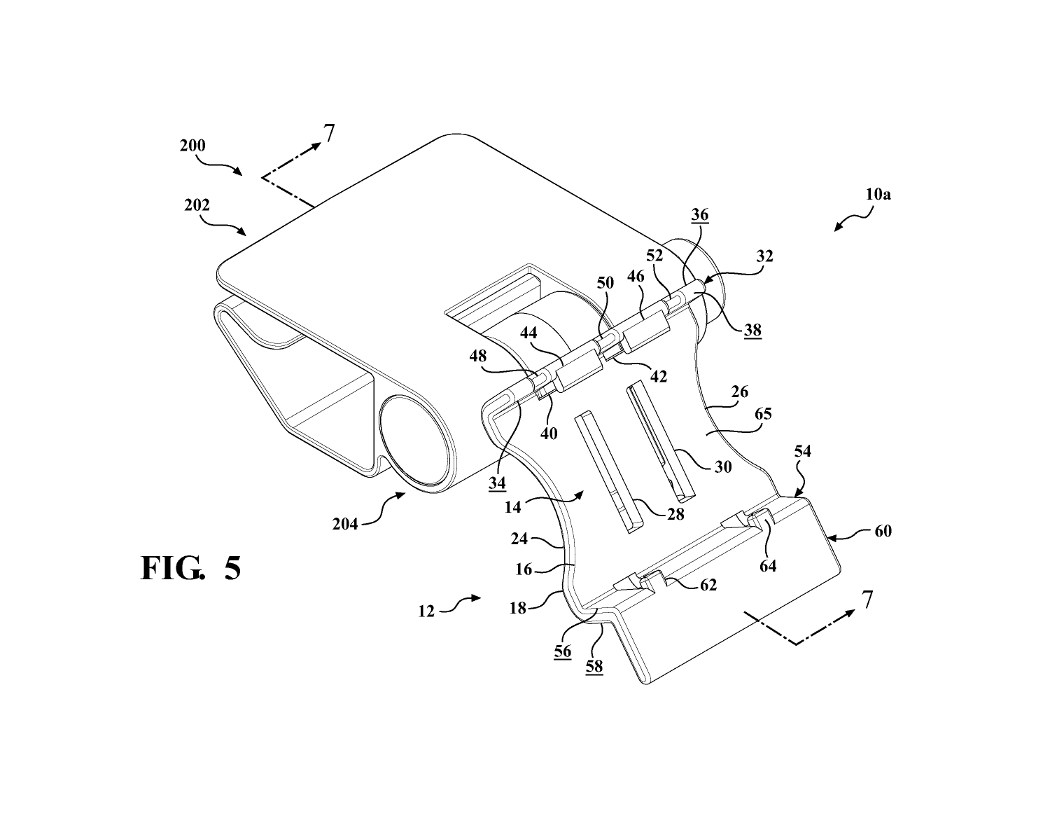

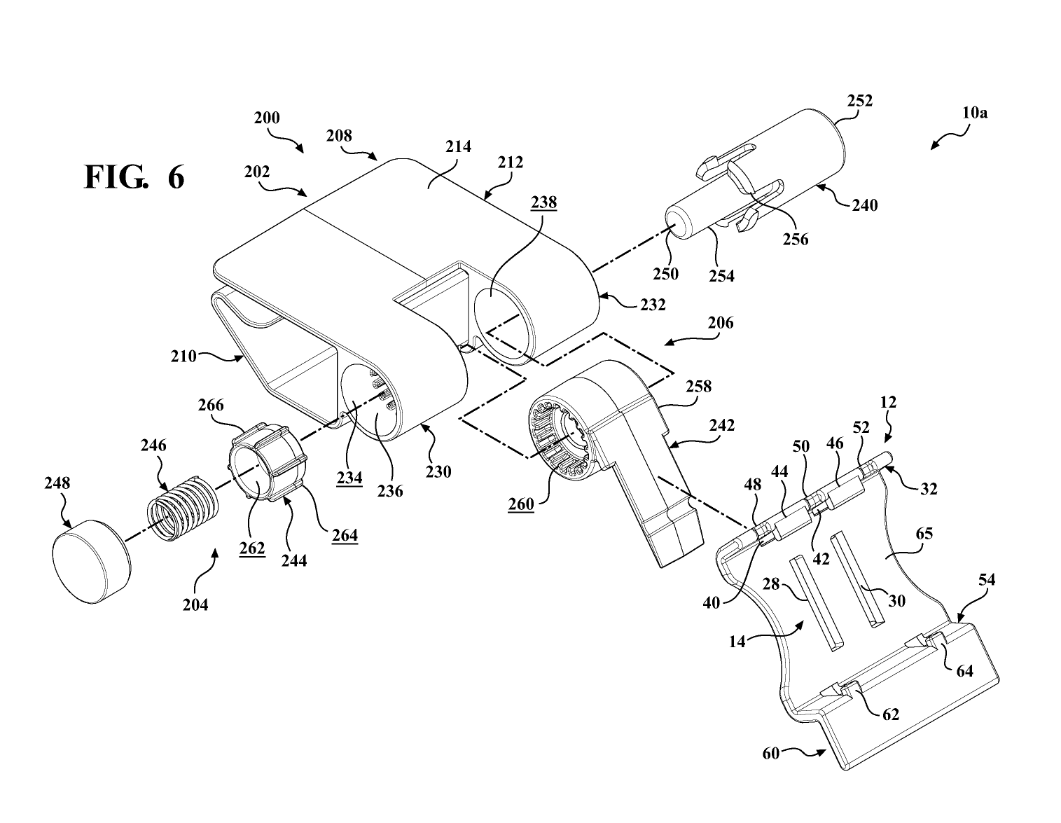

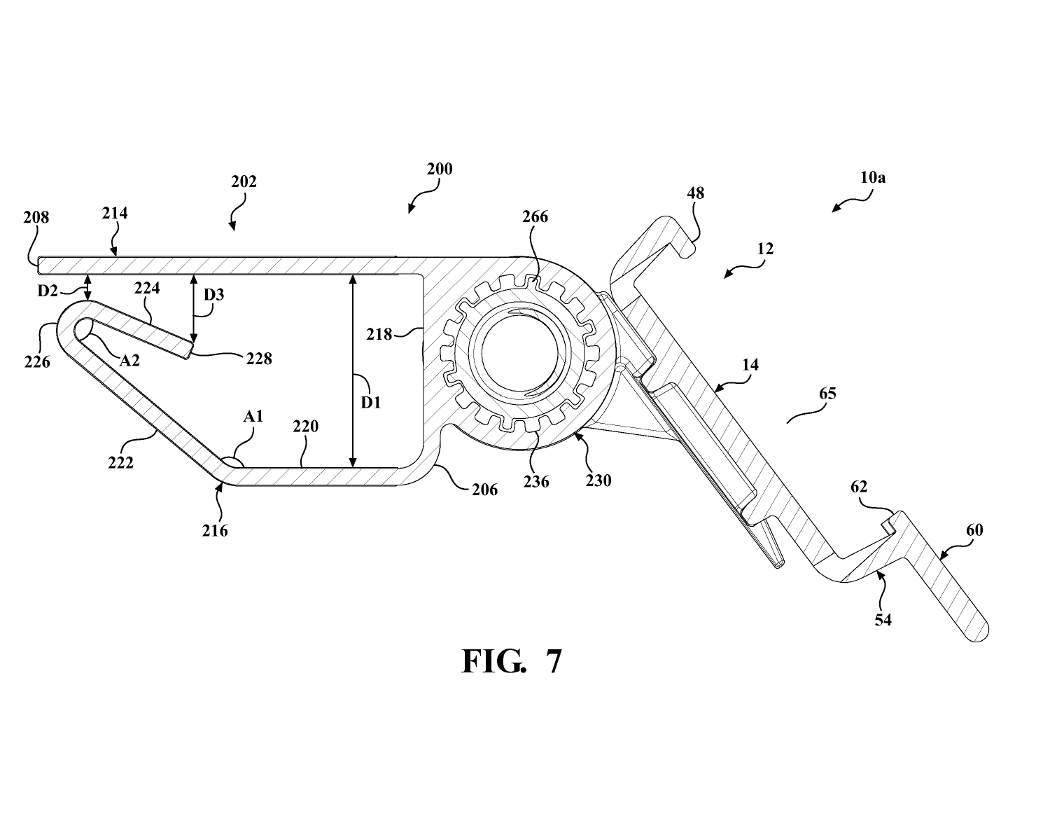

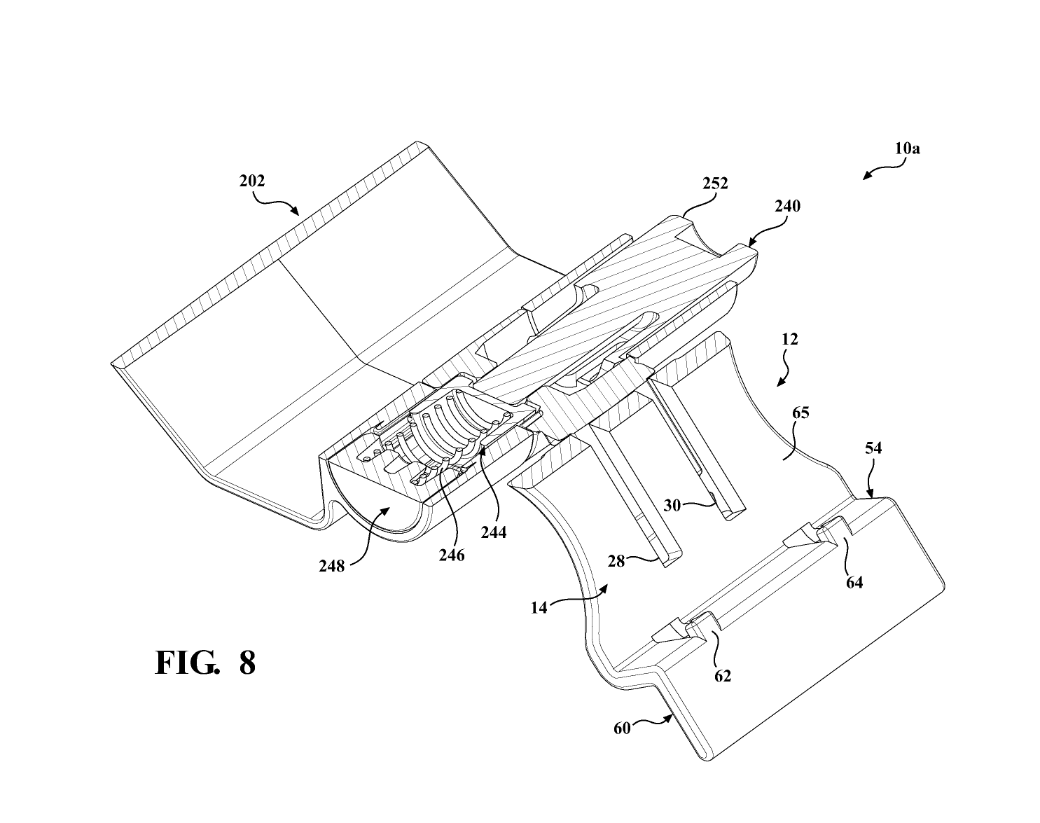

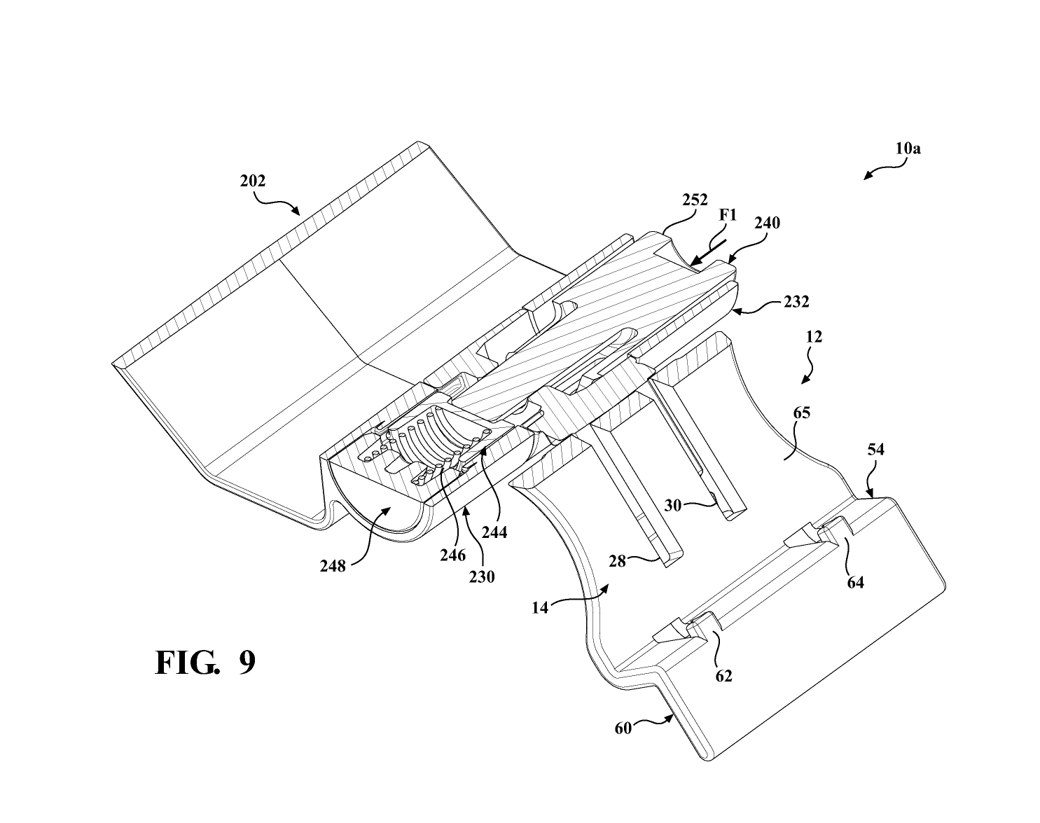

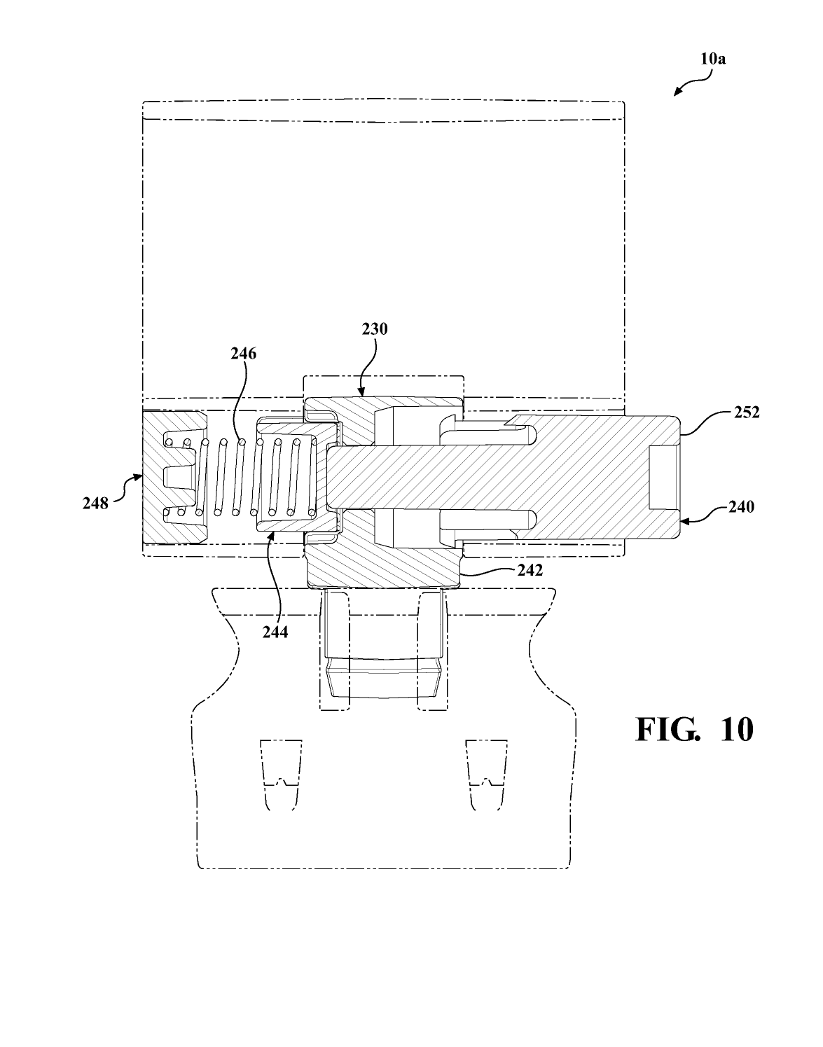

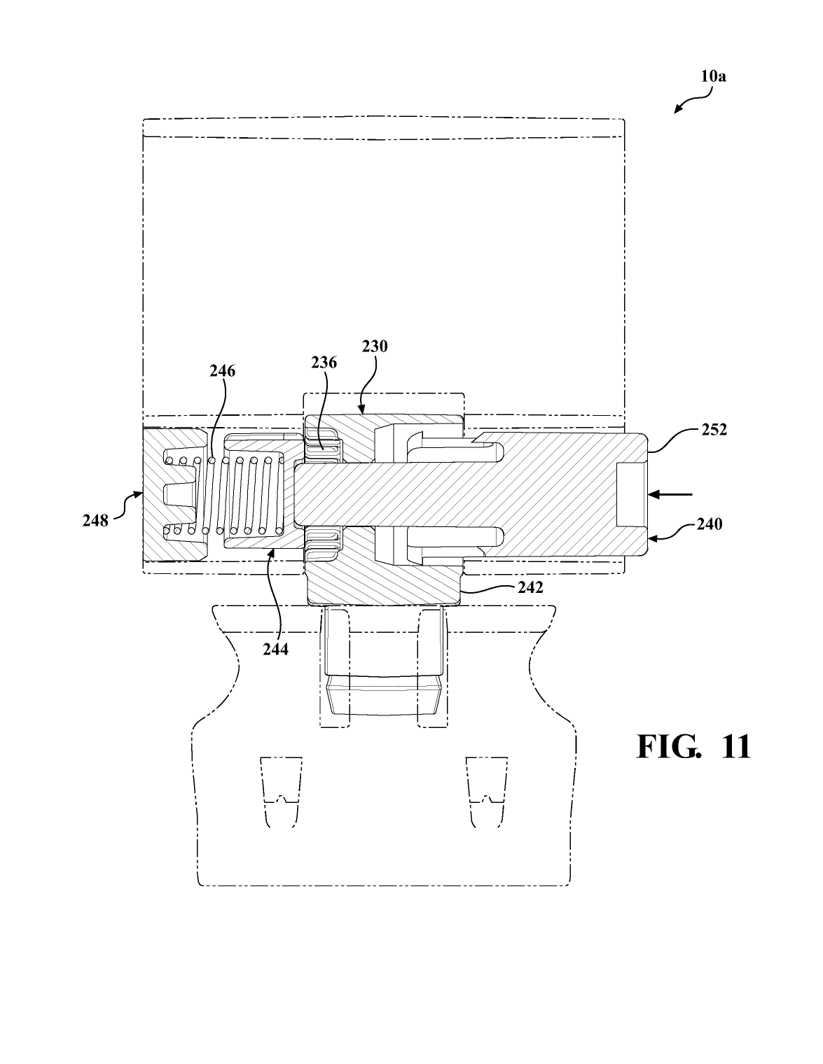

With particular reference to FIGS. 5-11, an attachment device 10a is provided and includes the holder 12 and an attachment mechanism 200 in lieu of the clip 100. In view of the substantial similarity in structure and function of the components associated with the device 10 with respect to the device 10a, like reference numerals are used hereinafter and in the drawings to identify like components while like reference numerals containing letter extensions are used to identify those components that have been modified.

The attachment mechanism 200 includes a clip 202 and a ratcheting mechanism 204. The clip 202 is configured to attach the attachment device 10a to the shelf. The clip 202 has a front end 206 facing towards the holder 12 and a rear end 208 that is opposite the front end 206 and facing away from the holder 12. The clip 202 also has a first side 210 and a second side 212 opposite the first side 210. The clip 202 has an upper retention lip 214, a lower retention lip 216, and a front wall 218. The front wall 218 extends from the first side 210 to the second side 212 of the clip 202 and connects the upper retention lip 214 to the lower retention lip 216.

The lower retention lip 216 includes a bottom segment 220 that is attached to, and extends away from, the front wall 218 and is generally parallel to the upper retention lip 214. The bottom segment 220 is spaced apart from the upper retention lip 214 by a distance D1. The lower retention lip 216 further includes a first mounting segment 222 that attaches to, and extends away from, the bottom segment 220 at an angle A1 towards the upper retention lip 214. In some examples, the angle A1 is an oblique angle. The lower retention lip 216 further includes a second mounting segment 224 with a proximal end 226 and a distal end 228. The proximal end 226 attaches to the first mounting segment 222 and converges towards the bottom segment 220 along a direction from the proximal end 226 to the distal end 228. The second mounting segment 224 forms an angle A2 with the first mounting segment 222. The angle A2 may be an acute angle. The proximal end 226 is spaced apart from the upper retention lip 214 by a distance D2 which is less than the distance D1. Moreover, the distal end 228 is spaced apart from the upper retention lip 214 by a distance D3 which is greater than the distance D2 and less than the distance D1.

The clip 202 further includes a first rotation shaft housing 230 and a second rotation shaft housing 232. The first rotation shaft housing 230 is attached to the front wall 218 and faces the holder 12 at the first side 210 of the clip 202. The first rotation shaft housing 230 includes an inner surface 234 whereby a plurality of female teeth or grooves 236 are disposed on at least a portion of the inner surface 234. The second rotation shaft housing 232 is attached to the front wall 218 and faces the holder 12. The second rotation shaft housing 232 includes an inner surface 238 without any teeth or grooves. The first rotation shaft housing 230 and the second rotation shaft housing 232 may be integrally formed with the upper retention lip 214.

The ratcheting mechanism 204 includes a push button 240, a lever arm 242, a locking nut 244, a biasing spring 246, and a cap 248. The push button 240 extends through the second rotation shaft housing 232 and at least a portion of the first rotation shaft housing 230. The push button 240 includes a first end 250 and a second end 252 opposite the first end 250. The push button 240 may also include a plunger 254 surrounded by one or more arms 256. The plunger 254 and the one or more arms 256 extend away from the first end 250 of the push button 240.

The lever arm 242 includes, or is attached to, a cylindrical passage 258 that aligns with the first rotation shaft housing 230 and the second rotation shaft housing 232. More specifically, the cylindrical passage 258 is disposed between the first rotation shaft housing 230 and the second rotation shaft housing 232. The cylindrical passage 258 includes an inner surface with a plurality of female teeth or grooves 260. In some examples, the number of female grooves 260 is greater than the number of female grooves 236 of the first rotation shaft housing 230. The locking nut 244 includes an inner surface 262 and an outer surface 264 that has a plurality of outward facing grooves or ribs 266 (ribs are shown in the illustrated example). The locking nut 244 is at least partially disposed within the cylindrical passage 258 and at least partially disposed within the first rotation shaft housing 230 when the push button 240 is not pressed (i.e., the ratcheting mechanism is in the resting position). As such, the outward facing ribs 266 of the locking nut 244 are configured to engage the female grooves 236 of the first rotation shaft housing 230 and the female grooves 260 of the cylindrical passage 258.

The biasing spring 246 is in communication with (i.e., in contact with) the locking nut 244. The cap 248 is attached to the first rotation shaft housing 230 such that the cap 248 is in contact with the biasing spring 246 such that the biasing spring 246 is compressed. The compression of the biasing spring 246 causes the biasing spring 246 to exert a force against the locking nut 244 and the push button 240 causing the locking nut 244 and the push button 240 to move in a direction towards the second end 252 of the push button 240 (i.e., an extended position). Thus, at a resting position when the push button 240 is not depressed, the outward facing ribs 266 of the locking nut 244 are engaged with the female grooves 236 of the first rotation shaft housing 230 and the female groove 260 of the cylindrical passage 258.

The female grooves 236 of the first rotation shaft housing 230 are rotationally fixed such that the engagement between the female grooves 236 and the outward facing ribs 266 prevents the locking nut 244 or the cylindrical passage 258 from rotating. That is, since the outward facing ribs 266 of the locking nut 244 are engaged with the female grooves 236 of the first rotation shaft housing 230 and the female grooves 260 of the cylindrical passage 258, the locking nut 244 prevent the cylindrical passage 258 of the lever arm 242 from rotating relative to the clip 202 when the push button 240 is not depressed (i.e., in the extended position).

On the other hand, in the depressed position when a force F1 is exerted upon the second end 252 of the push button 240 towards the first end 250 of the push button 240, the force F1 may overcome the force of the biasing spring 246 such that the plunger 254 contacts the locking nut 244 and displaces the locking nut 244 such that the outward facing ribs 266 disengage from the female grooves 260 of the cylindrical passage 258. As a result, when the push button 240 is depressed, the lever arm 242 is free to rotate relative to the clip 202 so long as the push button 240 remains depressed. Thus, the lever arm 242 may rotate to adjust the angle of the lever arm 242 with respect to the clip 202 while the push button 240 is depressed. Upon releasing the push button again, the outward facing ribs 266 of the locking nut 244 reengage the female grooves 260 of the cylindrical passage 258 such that the locking nut 244 secures the angle of the lever arm 242 from rotating. Since the lever arm 242 attaches to the rear side 18 of the rear wall 14, when the lever arm 242 is prevented from rotating, so is the holder 12.

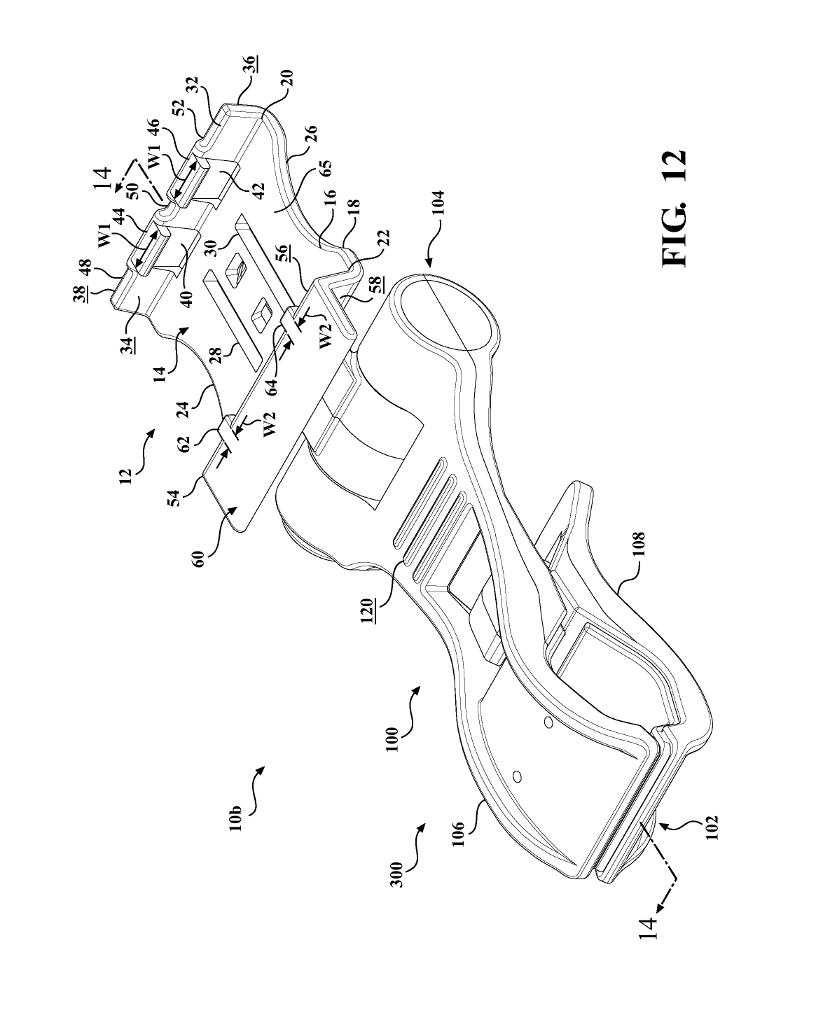

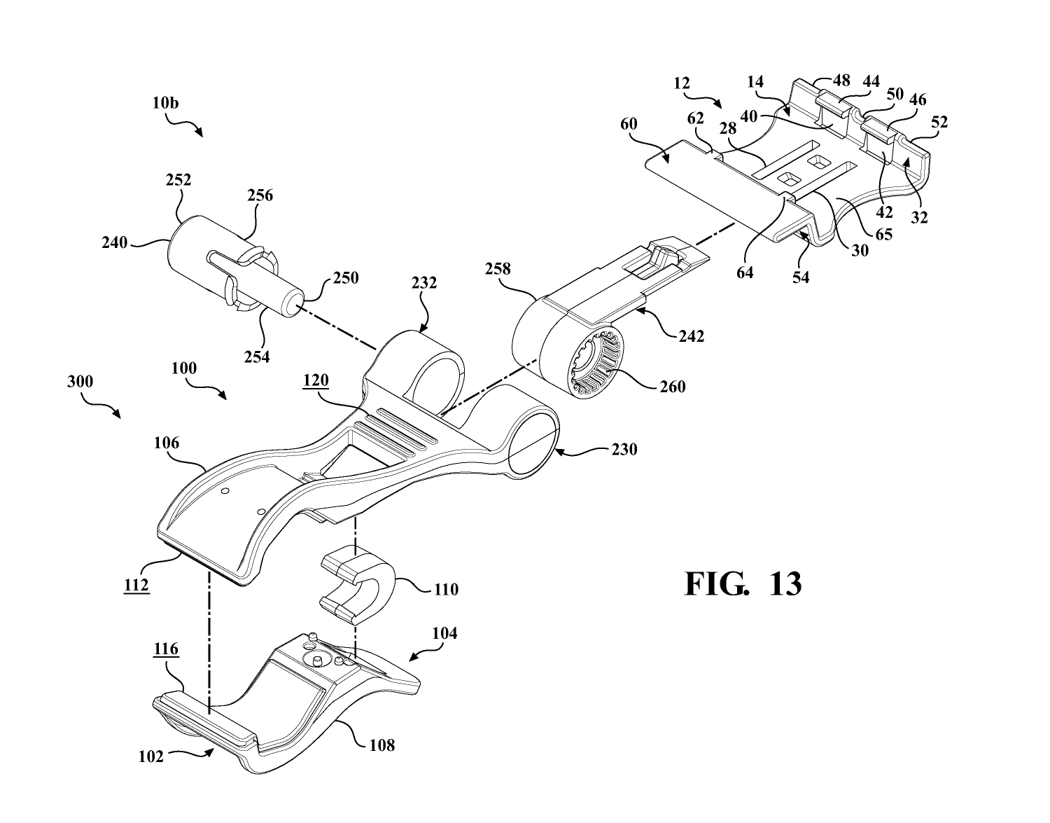

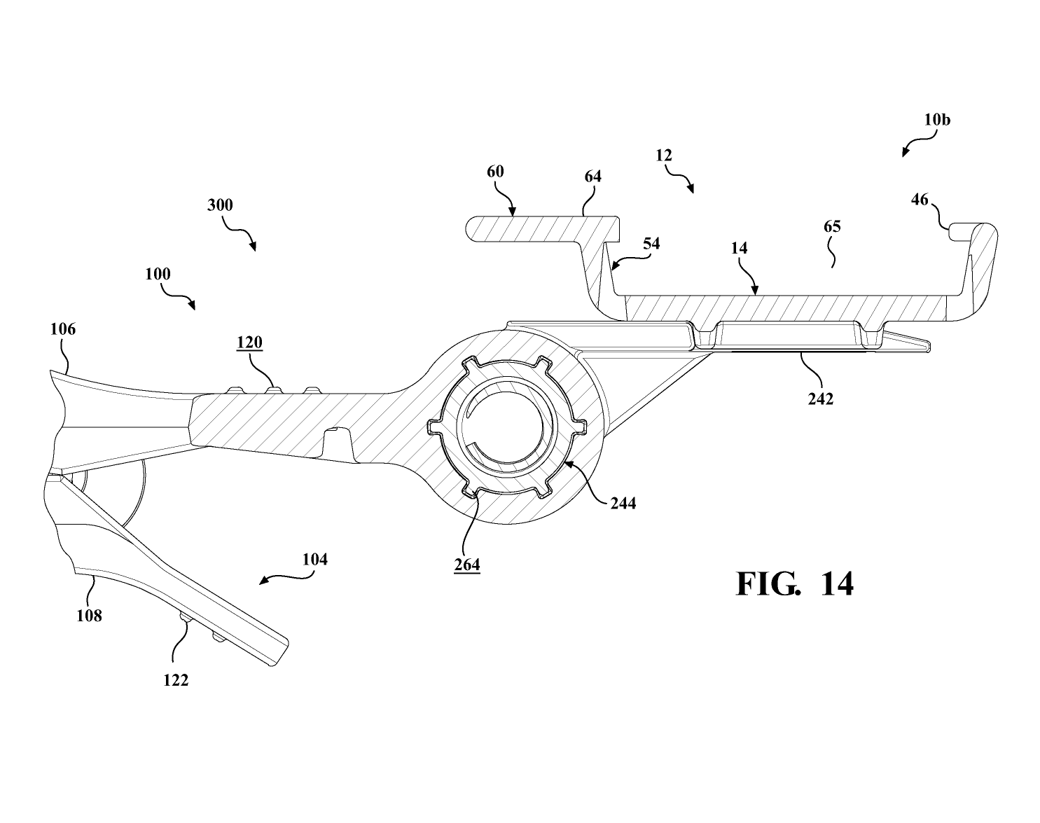

With particular reference to FIGS. 12-14, an attachment device 10b is provided and includes the holder 12 and an attachment mechanism 300. In view of the substantial similarity in structure and function of the components associated with the device 10 with respect to the device 10b, like reference numerals are used hereinafter and in the drawings to identify like components while like reference numerals containing letter extensions are used to identify those components that have been modified.

The attachment device 10b includes the holder 12 and the attachment mechanism 300 including the clip 100 with the ratcheting mechanism 204 (e.g., in lieu of the ball socket interface). The clip 100 is configured to attach the electronic shelf label holder (i.e., attachment device) 10 to a shelf edge or other support structure. The clip 100 has a first end 102 that faces away from the holder 12 and a second end 104 that faces the holder 12 and is opposite the first end 102. The clip 100 includes a first jaw 106, a second jaw 108, and a biasing clip 110. The first jaw 106 includes a first clamping surface 112 at the first end 102 of the clip 100 and a first clamp member 114. The second jaw 108 includes a second clamping surface 116 at the first end 102 of the clip 100 and a second clamp member 118. The biasing clip 110 biases the first jaw 106 and the second jaw 108 towards the closed position. The biasing clip 110 attaches to, and exerts a force upon, the first clamp member 114 and the second clamp member 118 that causes the first clamping surface 112 and the second clamping surface 116 to move towards one another. The first jaw 106 includes a first ribbed surface 120 at the second end 104 of the clip 100 and the second jaw 108 includes a second ribbed surface 122 at the second end 104 of the clip 100. A user may apply a force to the first ribbed surface 120 and the second ribbed surface 122 to open the clip 100.

The first clamping surface 112 and the second clamping surface 116 are configured to grip a shelf edge or other support structure securely and prevent slippage or detachment of the electronic shelf label holder. The first clamping surface 112 and the second clamping surface 116 may have various shapes, sizes, and textures to accommodate different types and thicknesses of shelf edges or other support structures. For example, the first clamping surface 112 and the second clamping surface 116 may have flat, curved, serrated, or rubberized surfaces.

The first ribbed surface 120 and the second ribbed surface 122 are configured to provide a user with a tactile and visual indication of where to apply a force to open the clip 100. The first ribbed surface 120 and the second ribbed surface 122 may have various shapes, sizes, and patterns to facilitate the user's grip and manipulation of the clip 100. For example, the first ribbed surface 120 and the second ribbed surface 122 may have longitudinal, transverse, diagonal, or spiral ribs. The first ribbed surface 120 and the second ribbed surface 122 may also have different colors, markings, or symbols to distinguish the clip 100 from other components of the electronic shelf label holder 10

The ratcheting mechanism 204 includes a push button 240, a lever arm 242, a locking nut 244, a biasing spring 246, and a cap 248. The push button 240 extends through the second rotation shaft housing 232 and at least a portion of the first rotation shaft housing 230. The push button 240 includes a first end 250 and a second end 252 opposite the first end 250. The push button 240 may also include a plunger 254 surrounded by one or more arms 256. The plunger 254 and the one or more arms 256 extend away from the first end 250 of the push button 240.

The lever arm 242 includes, or is attached to, a cylindrical passage 258 that aligns with the first rotation shaft housing 230 and the second rotation shaft housing 232. More specifically, the cylindrical passage 258 is disposed between the first rotation shaft housing 230 and the second rotation shaft housing 232. The cylindrical passage 258 includes an inner surface with a plurality of female teeth or grooves 260. In some examples, the number of female grooves 260 is greater than the number of female grooves 236 of the first rotation shaft housing 230. The locking nut 244 includes an inner surface 262 and an outer surface 264 that has a plurality of outward facing teeth or ribs 266 (ribs are shown in the illustrated example). The locking nut 244 is at least partially disposed within the cylindrical passage 258 and at least partially disposed within the first rotation shaft housing 230 when the push button 240 is not pressed (i.e., the ratcheting mechanism is in the resting position). As such, the outward facing ribs 266 of the locking nut 244 are configured to engage the female grooves 236 of the first rotation shaft housing 230 and the female grooves 260 of the cylindrical passage 258.

The biasing spring 246 is in communication with (i.e., in contact with) the locking nut 244. The cap 248 is attached to the first rotation shaft housing 230 such that the cap 248 is in contact with the biasing spring 246 such that the biasing spring 246 is compressed. The compression of the biasing spring 246 causes the biasing spring 246 to exert a force against the locking nut 244 and the push button 240 causing the locking nut 244 and the push button 240 to move in a direction towards the second end 252 of the push button 240 (i.e., an extended position). Thus, at a resting position when the push button 240 is not depressed, the outward facing ribs 266 of the locking nut 244 are engaged with the female grooves 236 of the first rotation shaft housing 230 and the female groove 260 of the cylindrical passage 258.

The female grooves 236 of the first rotation shaft housing 230 are rotationally fixed such that the engagement between the female grooves 236 and the outward facing ribs 266 prevents the locking nut 244 or the cylindrical passage 258 from rotating. That is, since the outward facing ribs 266 of the locking nut 244 are engaged with the female grooves 236 of the first rotation shaft housing 230 and the female grooves 260 of the cylindrical passage 258, the locking nut 244 prevent the cylindrical passage 258 of the lever arm 242 from rotating relative to the clip 100 when the push button 240 is not depressed (i.e., in the extended position).

On the other hand, in the depressed position when a force F1 is exerted upon the second end 252 of the push button 240 towards the first end 250 of the push button 240, the force F1 may overcome the force of the biasing spring 246 such that the plunger 254 contacts the locking nut 244 and displaces the locking nut 244 such that the outward facing ribs 266 disengage from the female grooves 260 of the cylindrical passage 258. As a result, when the push button 240 is depressed, the lever arm 242 is free to rotate relative to the clip 100 so long as the push button 240 remains depressed. Thus, the lever arm 242 may rotate to adjust the angle of the lever arm 242 with respect to the clip 100 while the push button 240 is depressed. Upon releasing the push button 240 again, the outward facing ribs 266 of the locking nut 244 reengage the female grooves 260 of the cylindrical passage 258 such that the locking nut 244 secures the angle of the lever arm 242 from rotating. Since the lever arm 242 attaches to the rear side 18 of the rear wall 14, when the lever arm 242 is prevented from rotating, so is the holder 12.

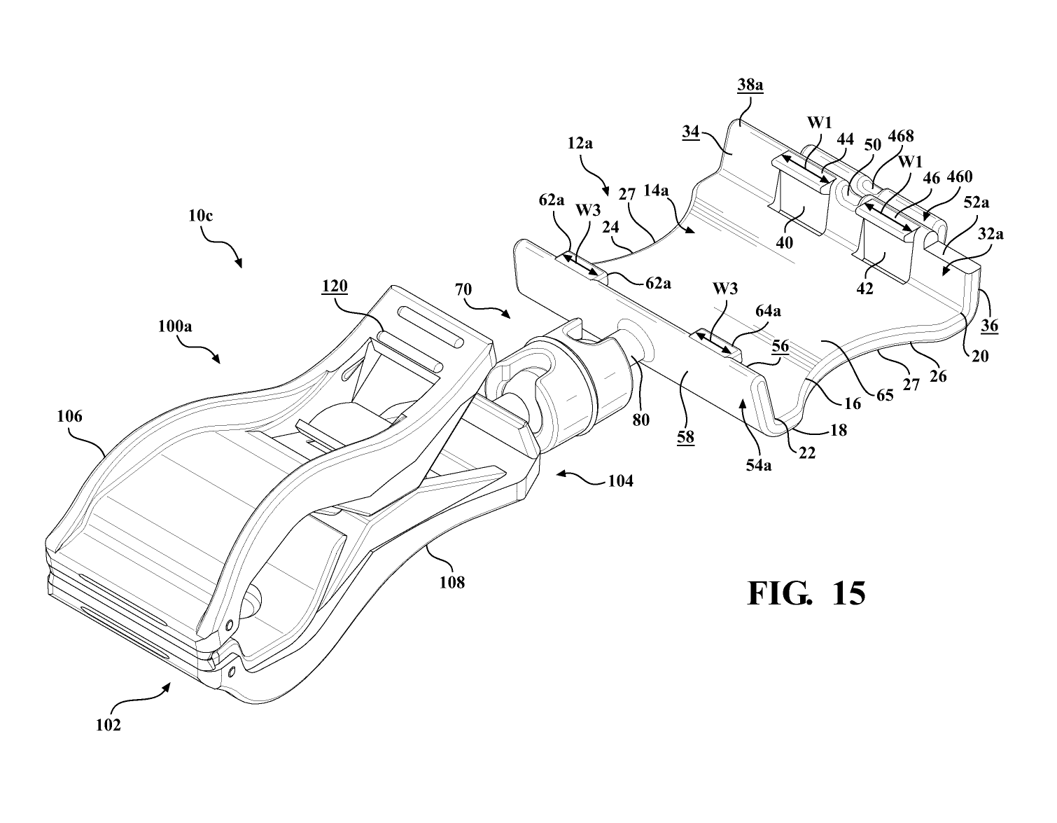

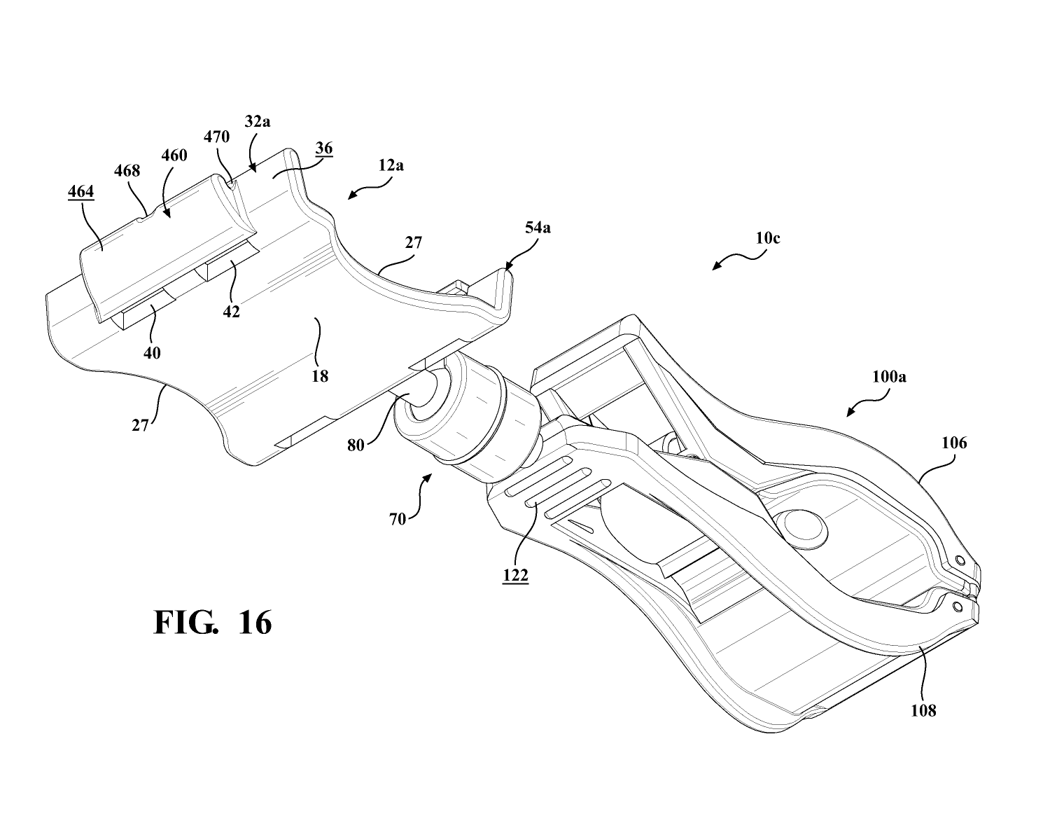

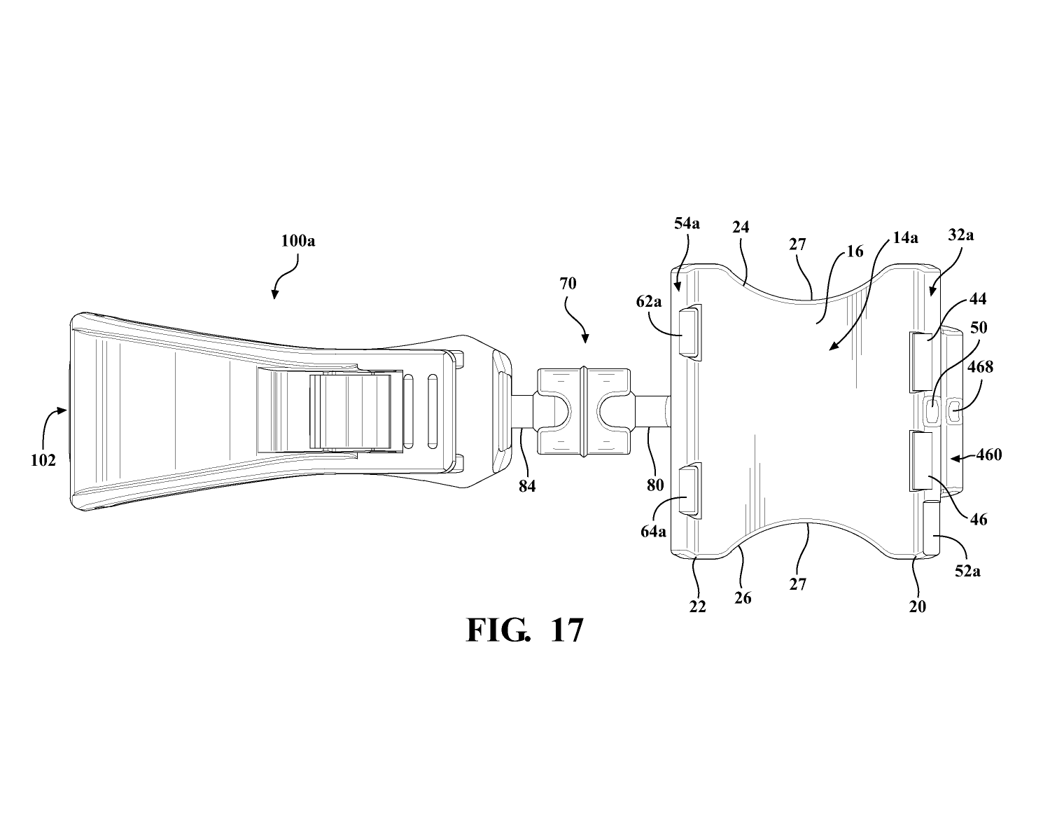

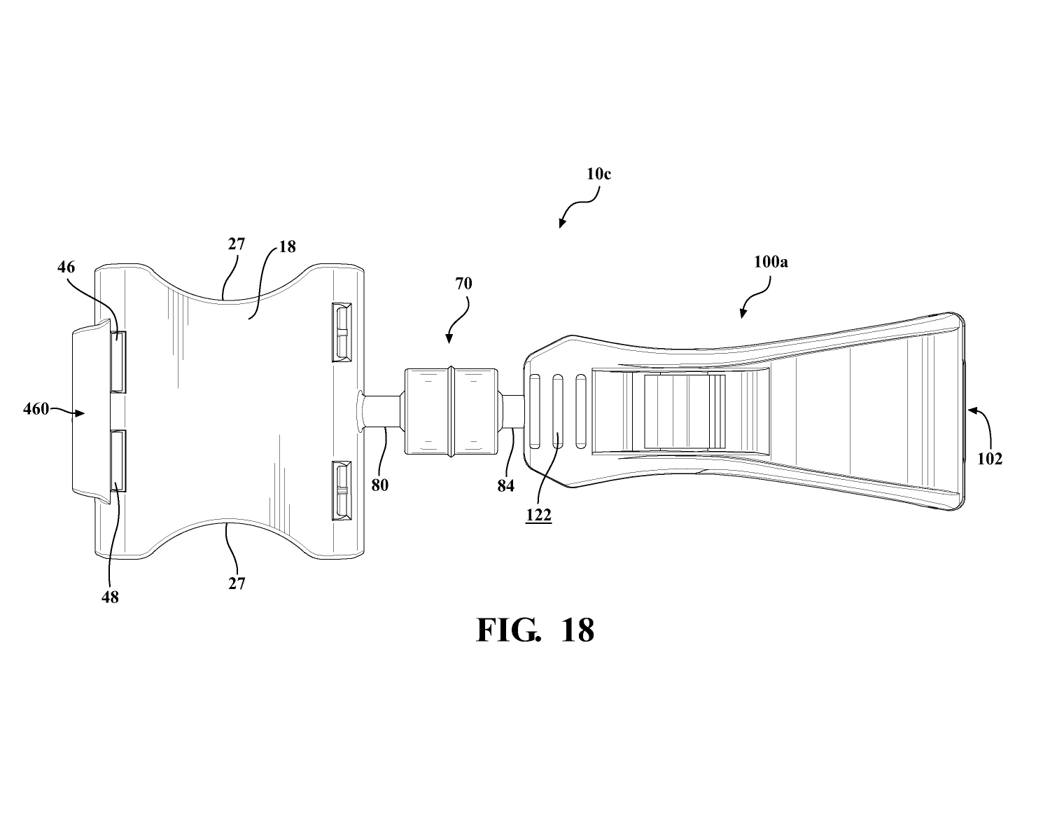

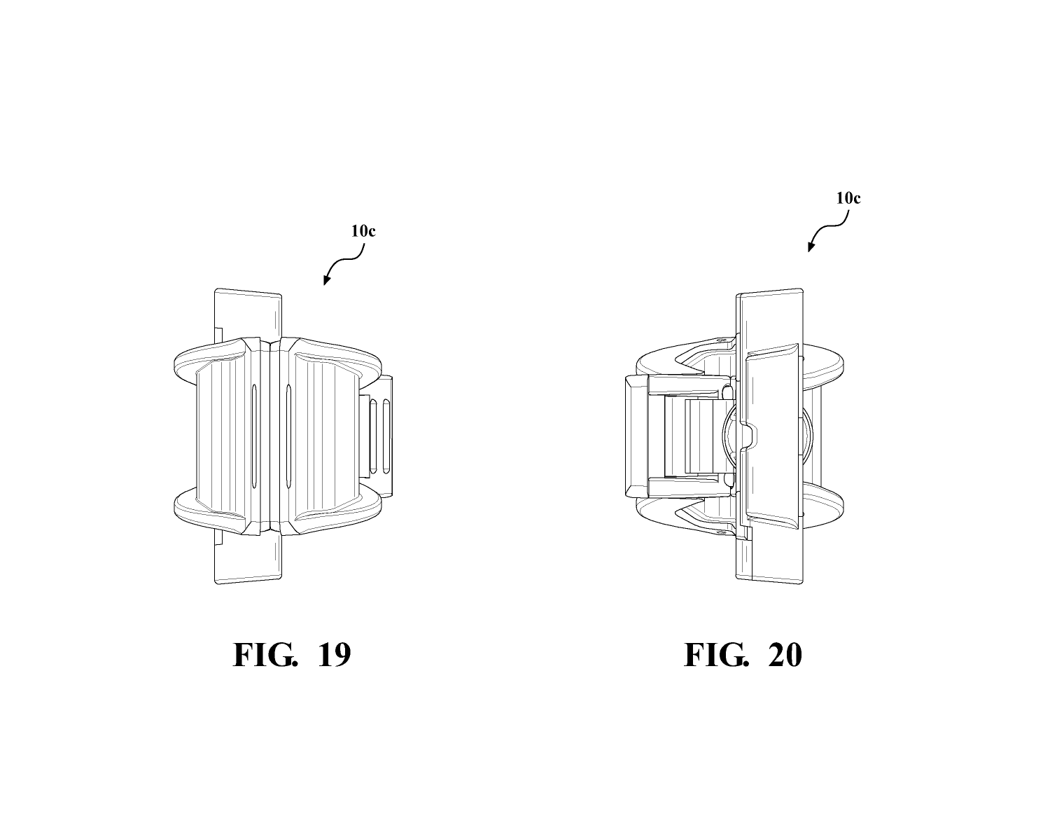

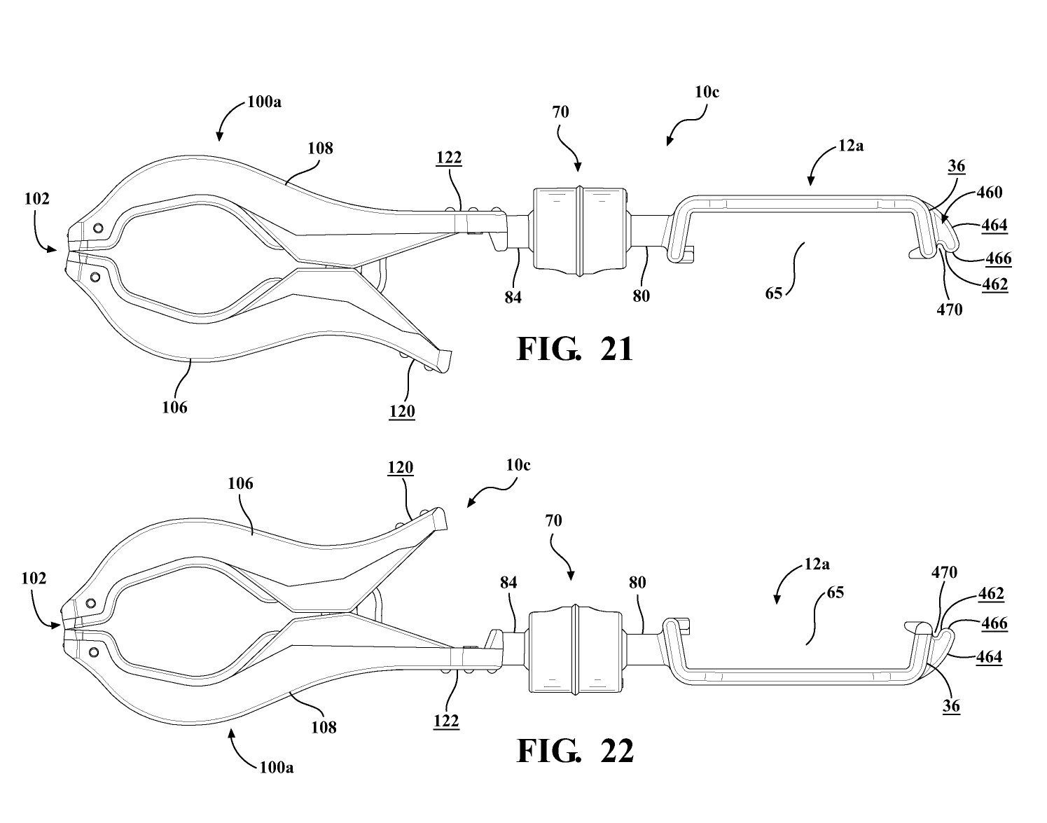

With particular reference to FIGS. 15-22, an attachment device 10c is provided and includes the holder 12a and an attachment mechanism 100a. In view of the substantial similarity in structure and function of the components associated with the device 10c with respect to the device 10, like reference numerals are used hereinafter and in the drawings to identify like components while like reference numerals containing letter extensions are used to identify those components that have been modified.

As shown in FIGS. 15-22, the attachment device 10c includes a holder 12a that is configured to receive and retain a display device (not shown), such as an electronic shelf label (ESL) or other display. The holder 12a includes a rear wall 14a that includes a front side 16a and a rear side 18a formed on an opposite side of the rear wall 14a than the front side 16a. The rear wall 14a may be defined as extending from an upper end 20 to a lower end 22 disposed on an opposite end of the rear wall 14a than the upper end 20 and extending from a first side 24 to a second side 26 disposed on an opposite side of the rear wall 14a than the first side 24. The first side 24 and the second side 26 extend from the upper end 20 to the lower end 22 and each include the arcuate recess 27 between the upper end 20 and the lower end 22.

The holder 12a further includes an upper retaining lip 32a and a lower retaining lip 54a. The upper retaining lip 32a is configured to engage with an upper edge of the electronic display (not shown) and prevent the electronic display from sliding out of the holder 12a. The upper retaining lip 32a is attached to, and extends along, the upper end 20 of the rear wall 14a from the first side 24 to the second side 26. The upper retaining lip 32a generally extends transversely (e.g., extending crosswise) from the front side 16 of the rear wall 14a at the upper end 20. In the illustrated example, the upper retaining lip 32a is perpendicular to the front side 16 of the rear wall 14a.

The upper retaining lip 32a includes the inward surface 34, the outward surface 36, and a forward-facing surface 38a. The inward surface 34 faces the lower retaining lip 54a and is formed on an opposite side of the upper retaining lip 32a than the outward surface 36, which faces away from the lower retaining lip 54a. The forward-facing surface 38a is disposed at a distal end of the upper retaining lip 32a and extends between the inward surface 34 and the outward surface 36.

The upper retaining lip 32a further includes the apertures 40, 42 that extend from the inward surface 34 through the outward surface 36. The upper retaining lip 32a further includes the upper retention tabs 44, 46 configured to retain the electronic display (not shown). That is, the upper retention tabs 44, 46 may engage or mate with recesses in the electronic display. The upper retention tabs 44, 46 extend from the forward-facing surface 38a and away from the inward surface 34. Each of the upper retention tabs 44, 46 may include a width W1. The upper retaining lip 32a may further include recesses 50, 52a formed in the forward-facing surface 38a. Notably, the recesses 50, 52a provide clearance for posts or flags of the ESL. This means that the recesses 50, 52a create space or gaps in the holder 12a that allow the posts or flags of the ESL to extend or project from the ESL without interfering with the holder 12a. Further, the recesses 50, 52a provide relief and allow additional flexibility of the retention tabs 44, 46 relative to the upper retaining lip 32a. In some implementations, the first recess 50 is disposed between the upper retention tab 44 and the upper retention tab 46, and the second recess 52a is disposed adjacent to the upper retention tab 46 and extending to the second side 26 of the rear wall 14a.

The holder 12a further includes a finger tab 460 attached to and arcuately extending from the outward surface 36 of the upper retaining lip 32a. A width of the finger tab 460 generally extends laterally (e.g., from first side 24 to second side 26) from the upper retention tab 46 of the upper retaining lip 32a to the upper retention tab 44 of the upper retaining lip 32a forming a width that is less than a width of the upper retaining lip 32a. The finger tab 460 includes an inward surface 462, an outward surface 464, and a forward-facing surface 468. The inward surface 462 faces the outward surface 36 of the upper retaining lip 32a and is formed on an opposite side of the finger tab 460 than the outward surface 464, which faces away from the outward surface 36 of the upper retaining lip 32a. The forward-facing surface 466 is disposed at a distal end of the finger tab 460 and extends between the inward surface 462 and the outward surface 464. The inward surface 462 is spaced apart from the outward surface 36 of the upper retaining lip 32a such that a channel 470 is formed between the finger tab 460 and the upper retaining lip 32a. The finger tab 460 may further include a recess 470 formed in the forward-facing surface 468 and aligned with the recess 50 of the upper retaining lip 32a. The channel 470 and recess 468 provide relief and allow additional flexibility of the finger tab 460 relative to the upper retaining lip 32a.

The lower retaining lip 54a is configured to engage with a lower edge of the ESL and prevent it from sliding out of the holder 12a. The lower retaining lip 54a extends along the lower end 22 of the rear wall 14a from the first side 24 to the second side 26. The lower retaining lip 54a generally extends transversely (e.g., extending crosswise) from the front side 16 of the rear wall 14a at the lower end 22. In the illustrated example, the lower retaining lip 54a is perpendicular to the front side 16 of the rear wall 14a. The lower retaining lip 54a includes an inward surface 56 and an outward surface 58. The inward surface 56 faces the upper retaining lip 32a and is formed on an opposite side of the lower retaining lip 54a than the outward surface 58 which faces away from the upper retaining lip 32a. The lower retaining lip 54a includes lower retention tabs 62a, 64a. Each of the lower retention tabs 62a, 64a may include a width W3. The width W3 of the lower retention tabs 62a, 64a may be smaller than the width W1 of the upper retention tabs 44, 46.

The holder 12a includes the cavity 65 defined by the rear wall 14a, the upper retaining lip 32a, and the lower retaining lip 54a. The cavity 65 is configured to receive and retain the ESL. The cavity 65 may have a shape and size that correspond to the shape and size of the electronic display. The finger tab 460 provides an interface that a user may press to disengage the upper retention tabs 44, 46 from the electronic display. That is, when an ESL is secured by the lower retention tabs 62a, 64a and the upper retention tabs 44, 46, the user may apply a force to the finger tab 460 to flex the upper retaining lip 32a in a direction away from the lower retaining lip 54a, which thereby causes the upper retention tabs 44, 46 to disengage from the ESL to remove the display device from the holder 12a. Alternatively, the user may apply the force to the finger tab 460 to increase the distance between the upper retention tabs 44, 46 and the lower retention tabs 62a, 64a such that the user may generate enough clearance to insert the electronic display within the holder 12a.

The holder 12a may further include the first stem 80. The first stem 80 attaches to, and extends from, the outward surface 58 of the lower retaining lip 54a. Particularly, the first stem 80 may be aligned with the center point of the rear wall 14a of the holder 12a.

Thus, the first stem 80 connects the articulating interface 70 to the holder 12a.

Referring still to FIGS. 15-22, the attachment device further includes a clip 100a configured to attach the electronic shelf label holder to a shelf edge or other support structure. As can be seen from the illustrated examples, the clip 100a is substantially the same as the clip 100, except that the second stem 84 instead extends from the second jaw 108. Thus, the second stem 84 connects the second jaw 108 to the articulating interface 70.

The terminology used herein is for describing particular exemplary configurations only and is not intended to be limiting. As used herein, the singular articles "a," "an," and "the" may be intended to include the plural forms as well, unless the context clearly indicates otherwise. The terms "comprises," "comprising," "including," and "having," are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being "on," "engaged to," "connected to," "attached to," or "coupled to" another element or layer, it may be directly on, engaged, connected, attached, or coupled to the other element or layer, or intervening elements or layers may be present. In contrast, when an element is referred to as being "directly on," "directly engaged to," "directly connected to," "directly attached to," or "directly coupled to" another element or layer, there may be no intervening elements or layers present. Other words used to describe the relationship between elements should be interpreted in a like fashion (e.g., "between" versus "directly between," "adjacent" versus "directly adjacent," etc.). As used herein, the term "and/or" includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as "first," "second," and other numerical terms do not imply a sequence or order unless clearly indicated by the context. Thus, a first element, component, region, layer or section discussed herein could be termed a second element, component, region, layer or section without departing from the teachings of the example configurations.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An attachment device for securing a display to a retail shelf, the attachment device comprising:a holder configured to receive and retain the display, the holder including:a rear wall extending from an upper end to a lower end formed on an opposite end from the upper end;an upper retaining lip attached to the upper end of the rear wall, the upper retaining lip comprising an inward surface facing the lower end and an outward surface facing away from the lower end; anda lower retaining lip attached to the lower end of the rear wall, the lower retaining lip including an inward surface facing the upper retaining lip and an outward surface facing away from the upper retaining lip.

2. The attachment device of claim 1, wherein the rear wall includes a first rear rail and
a second rear rail defining a channel.

3. The attachment device of claim 2, wherein each rear rail includes side members and a base member.

4. The attachment device of claim 1, wherein the upper retaining lip further includes at least one upper retention tab extending away from the inward surface.

5. The attachment device of claim 4, wherein the upper retaining lip further includes:a forward-facing surface disposed at a distal end; anda first recess, a second recess, and a third recess each formed in the forward-facing surface, the first recess disposed between a first one of the upper retention tabs and a first side of the rear wall, the second recess disposed between the first one of the upper retention tabs and a second one of the upper retention tabs, and the third recess disposed between the second one of the upper retention tabs and a second side of the rear wall.

6. The attachment device of claim 1, wherein the lower retaining lip further comprises a first lower retention tab and a second lower retention tab.

7. The attachment device of claim 1, wherein the lower retaining lip further comprises
a release tab extending away from the lower retaining lip and configured to disengage lower retaining lip from the display.

8. The attachment device of claim 1, further comprising an articulating interface including:a socket having a first cavity and a second cavity on opposite ends of the socket;afirst ball element received within the first cavity and having a spherical surface and a first stem extending from the first ball element; anda second ball element received within the second cavity and having a spherical surface and a second stem extending from the second ball element.

9. The attachment device of claim 8, wherein:the first ball element is configured to articulate within the first cavity; andthe second ball element is configured to articulate within the second cavity.

10. The attachment device of claim 8, wherein the socket further comprises a base separating the first cavity from the second cavity.

11. The attachment device of claim 1, further comprising a clip attached to the holder and configured to attach the attachment device to the retail shelf.

12. An attachment device for securing a display to a retail shelf, the attachment device comprising:a holder configured to receive and retain the display; andan attachment mechanism attached to the holder and configured to attach the
attachment device to the retail shelf, the attachment mechanism including:
a clip comprising a front wall facing towards the holder; and a ratcheting mechanism disposed within the housing, the ratcheting mechanism comprising a push button, a lever arm attached to the holder, a locking nut, and a biasing spring, the ratcheting mechanism configured to enable rotation of the lever arm
and the housing with the push button depressed and prevent rotation of the lever arm and the housing with the push button at rest.

13. The attachment device of claim 12, wherein the clip further comprises an upper retention lip and a lower retention lip, the front wall connecting the upper retention lip to
the lower retention lip.

14. The attachment device of claim 13, wherein the lower retention lip comprises:a bottom segment attached to and extending away from the front wall and spaced apart from the upper retention lip by a first distance;a first mounting segment attached to, and extending away from the bottom segment at an oblique angle, towards the upper retention lip; anda second mounting segment having a proximal end and a distal end, the proximal end attached to the first mounting segment and extending towards the bottom segment, the second mounting segment forming an acute angle with the first mounting segment.

15. The attachment device of claim 14, wherein:the proximal end is spaced apart from the upper retention lip by a second distance that is less than the first distance; andthe distal end spaced apart from the upper retention lip by a third distance that is
greater than the second distance and less than the first distance.

16. The attachment device of claim 12, wherein the clip further comprises a first rotation shaft housing and a second rotation shaft housing each attached to the front wall of the clip, the first rotation shaft housing having an inner surface with a plurality of female
grooves and the second rotation shaft housing having an inner surface without any grooves.

17. The attachment device of claim 16, further comprising a ratcheting mechanism including:a push button extending through the second rotation shaft housing and at least a
portion of the first rotation shaft housing, the push button having a first end and a second end opposite the first end;a lever arm having a cylindrical passage that aligns with the first rotation shaft housing and the second rotation shaft housing, the cylindrical passage having an inner surface with a plurality of female grooves;a locking nut having an inner surface and an outer surface, the outer surface having a plurality of outward facing ribs;a biasing spring in communication with the locking nut and the push button, the biasing spring configured to exert a force against the locking nut and the push button causing the locking nut and the push button to move in a direction towards the second end
of the push button; anda cap attached to the first rotation shaft and in contact with the biasing spring.

18. The attachment device of claim 17, wherein the push button further has a plunger and one or more arms extending away from the first end of the push button.

19. The attachment device of claim 17, wherein the locking nut is at least partially disposed within the cylindrical passage and at least partially disposed within the first rotation shaft with the push button is at rest and the outward facing grooves are configured to engage the female grooves of the first rotation shaft housing and the female grooves of
the cylindrical passage with the push button at rest.

20. An attachment device for securing a display to a retail shelf, the attachment device comprising:a holder configured to receive and retain the display; anda clip attached to the holder and configured to attach the attachment device to the
retail shelf, the clip comprising a ratcheting mechanism comprising a push button, a lever arm attached to the holder, a locking nut, and a biasing spring, the ratcheting mechanism configured to enable rotation of the lever arm with the push button depressed and prevent rotation of the lever arm with the push button at rest.
